(19) United States
(12) Patent Application Publication
(10) Pub. No.: US 2024/0196921 A1
(43) Pub. Date: Jun. 20, 2024

(54) JELLY BEANS OR GUMMIES WITH A HIGH FRUIT CONTENT AND WITH FUNCTIONAL INGREDIENTS AND MANUFACTURING METHOD

(71) Applicant: NUTRIS INGREDIENTS, S.L., Madrid (ES)

(72) Inventor: Pedro DE LA FUENTE BLASCO, Madrid (ES)

(21) Appl. No.: 18/105,953

(22) Filed: Feb. 6, 2023

(30) Foreign Application Priority Data
Dec. 20, 2022 (ES) P202231081

(51) Int. Cl. A23G 3/48; A23G 3/34; A23G 3/42

(52) U.S. Cl. CPC A23G 3/48; A23G 3/001; A23G 3/0014; A23G 3/0038; A23G 3/42

(57) ABSTRACT

The present invention relates to jelly beans or gummies with fruit and functional ingredients in which the amount of fruit is at least 75% by weight of the final composition and with a maximum amount of 18.78% carbohydrates not from fruit, wherein the composition is: Fruits: 75-91.78%; Carbohydrates and/or sweeteners: 1-18.78%; Gelling agents: 1-10%; Aromas: 0.01%-5%; Colourings: 0.01%-5%; Functional ingredients (Food and Pharmaceutical): 0.1-25%; Water: 5-25% and Acid: 0.1-5% and PH correctors. The method comprises the steps of:
Preparing a base dough by mixing fruit,
Preparing a mixture with the aromas, flavours and other excipients,
Preparing a mixture of one or several functional ingredients,
Mixing all the previous doughs,
Depositing this mixture in trays with moulds,
Drying the filled moulds,
Demoulding the gummy,
Packaging the gummies,
   wherein
the amount of fruit is at least 75% by weight of the final composition and having a maximum amount of 18.78% carbohydrates not from fruit,
the base dough must not exceed a pH of 7.5, homogenising at a maximum temperature of 80° C., maintaining a density of less than 0.9 g/ml and a Brix graduation of more than 70.

### OBJECT OF THE INVENTION

It is the subject matter of the present invention, as the title of the invention establishes, a functional gummy having a high fruit content, not less than 75% and a maximum amount of carbohydrates not from fruit of 25%, as well as functional ingredients, including food ingredients (plant extracts, powdered plants, liquid or semisolid, amino acids, fruit (collagen among others), vitamins, minerals, oils, fibres, live or tyndallised probiotic microorganisms, parabiotics and/or pharmaceutical functional ingredients such as analgesics, antibiotics, corticosteroids, targeted at the central nervous system, anti-inflammatory, antivirals, anti-infectives, antifungals, antipyretics and/or stem cells or derivatives.

The present invention is characterised by the specific specifications of the gummy (jelly bean), since the main composition is based on fruit. The fruit used for this invention can be in the form of pure fruit, fruit juice, dehydrated powder, concentrate, freeze-dried or other natural fruit preparations. These fruit sources must have the appropriate specifications to achieve the gelation and adequate stability for the manufacture as per this invention. The manufacture of this new gummy will comprise a method made up of different steps, carried out in several phases, each of these phases aims to manufacture a specific dough that will form part of a final mixture called “final dough” that will become, after drying, the gummy as per this invention.

The term gummy in this invention encompasses a pharmaceutical form in the form of jelly bean that can be manufactured in numerous moulds and shapes. Therefore, the term gummy in this invention is synonymous with pharmaceutical form and/or jelly beans.

Therefore, the present invention is circumscribed within the scope of the manufacture of gummy-type sweets, as well as within a new food matrix with applications for health, as well as a new pharmaceutical form with application in the food, pharmaceutical, medical and in general in the food and health sectors.

### BACKGROUND OF THE INVENTION

Gummies are chewy candies that are usually, but not necessarily, sweet, made from jellies, pectins, starches, agar-agar, carragenates, collagen or other proteins or amino acids and other ingredients with gelling capacity to which sweeteners, food flavourings and colourings are added. They have a finish in order for them not to stick together, consisting of a coating based on vegetable oils, sugar or polyols, acids or some amino acids and/or proteins such as glycine among others. They have an infinite number of shapes: bears or other animals, cola bottles, rings, various fruits, tablets, capsules, etc.

Gummies can be considered a pharmaceutical form. So far no gummies with functional ingredients responsible for healthy activity are known, the main and majority composition of which is fruit and which have a maximum of 25% carbohydrates that do not come from the same fruit, since both the incorporation of the functional assets described above (including ingredients considered pharmaceutical), and the amounts greater than 75% fruit from the total weight of the gummy, involves a modification of the usual base that makes up these products, as well as the behaviour of the solubility and homogenisation of the liquid or semi-solid dough of the first manufacturing steps of the gummies, as well as a variation of the key parameters (pH, dry residue, Brix, solubility, temperature and moisture among others) that influence the gelling and/or solidifying process of this novel pharmaceutical form.

The manufacture of gummies with high fruit content involves a significant difficulty in the manufacture of gummies. For this reason, there are no gummies on the market the fruit percentage of which exceeds 75%.

The gummy requires a liquid or semi-solid base that reacts with the gelling agents and allows the gummy dough to solidify. Traditionally the liquid or semi-solid bases used are sugars, glucose syrups, sweeteners or other polysaccharides such as fibre. These compounds react with gelling agents such as pectin or gelatine (among others), without significantly altering the key parameters required for traditional gummy production as with organolepsy, the pH, Brix or high temperatures (above 80° C.) and achieve the solidification of the jelly gummies.

The replacement of traditional bases, described above, with fruit implies a significant difficulty to achieve the correct and stable gelation of the gummy. This circumstance is complicated if we additionally introduce functional ingredients into the formula.

Therefore, it is the object of the present invention to develop gummies with healthy functional ingredients, either food or pharmaceutical, with a majority base of fruit not less than 75% of the total composition of the gummy and with a maximum of 25% carbohydrates not from fruit, that do not involve a significant change in the solubility of the dough and the pH, nor any impediment in the gelling process during the manufacture of the jelly beans, developing a process such as the one described below and which is included in its essentials in the first claim.

### DESCRIPTION OF THE INVENTION

The object of the present invention is a gummy with either food or pharmaceutical functional ingredients (as described in the Object of the invention) with a majority composition of at least 75% fruit and with a maximum of 25% carbohydrates not from fruit in any of its forms. The composition of the gummies or jelly beans or gummy-based pharmaceutical form disclosed by this invention shall be:
1.—Fruit: 75-91.78%
2.—Carbohydrates and/or sweeteners not from Fruit: 1-18.78%
3.—Gelling agents: 1-10%
4.—Aromas: 0.01%-5%
5.—Colourings: 0.01%-5%
6.—Functional ingredients (Food and Pharmaceutical): 0.1-25%
7.—Water: 5-25%
8.—Acid: 0.1-5%

Wherein the percentages are percentages by weight of the final composition.
Additionally, they can carry:
aromas, flavours and other excipients that interfere with the organolepsy of the gummy, as well as the pH
pH correctors
Specific coatings based on sugar, sweeteners, fruit, fibre, acid, amino acids, proteins, bacteria.
The sum total of the ingredients described must add up to 100% and no less than 75% must be fruit.

This gummy is carried out by means of a manufacturing method comprising the following steps:
On the one hand, first, the dough, “base dough”, is prepared which is going to make up the gummy by means of the mixture of fruit, in any of the ways described above, and sugar and/or glucose syrup and/or vegetable, animal, synthetic or fermentation fibres and/or sweeteners, water and gelatine or pectin or agar-agar or starch or collagen or carragenates or other gelling agents. Sources of carbohydrates other than fruit, the maximum amount of which cannot exceed 18.78% can be sugars, fibres such as polydextrose and other vegetable fibres such as Fructologosaccharides. Fruit sources will be mainly, but not exclusively, semi-solid, since we have verified that both the powder fruit and that which is in a liquid or chopped state, can be part of this new gummy or pharmaceutical form. These ingredients could be organic and therefore call the product as such. The exact amounts of ingredients common to other gummies (gelling agent, aromas, colourings, carbohydrates, acid, etc.) are not always the same, but each factory plays with certain proportions that in the end will give the gummy a texture, consistency and organolepsy specific to the gummy. In this invention it is specified that the minimum amount of fruit will be 75% of the final composition of the gummy, therefore, in this first phase of preparation, the initial dough will have to have a minimum amount of 75% fruit as well as a maximum amount of 18.78% carbohydrates not from fruit.
This base dough must meet a series of key specifications such as not exceeding a pH of 4.5, homogenising at a maximum temperature of 80° C., maintaining a density of less than 0.9 g/ml and a Brix graduation of more than 70. The simultaneous achievement of all these parameters is the main difficulty that must be overcome during the manufacturing process, since all the parameters are influenced by and related to each other, for example, the temperature can generate variations on the density and Brix graduation. For this reason, the handling of this base dough involves specific experience in this process and it is not possible for a skilled person in traditional gummies to be able to reproduce it without previous experience with this specific mixture.
On the other hand, in a complementary manner, a mixture is further prepared with the aromas, flavours and other excipients that interfere with the organolepsy of the gummy, as well as the pH, which is basic for the gummy to finally gel and become consistent. This mixture is called Organoleptic dough.
Next, a mixture of one or more functional ingredients is prepared, which will consist of mixing one or more active ingredients, either food or pharmaceutical. This preparation will be made through a homogenisation of the ingredients that allows their incorporation into the final Mixture described below; in a stable manner that guarantees their non-degradation.
Next, all previous doughs, that is, the base dough, the Organoleptic dough and the functional ingredients dough are mixed in a single dough called final Mixture or dough. This mixing must be done at a maximum temperature of 90° C. and a moisture of less than 25% and with a maximum pH between 1-7.5 to guarantee the conservation of the active ingredients that provide functionality to the gummy. The mixing of the doughs must be done at low revolutions, with a gentle and constant stirring process and for a maximum time of 30 minutes in order to avoid the start of the gelling process in the mixing tanks.
Next, this mixture is deposited in trays with a starch base or on metal, plastic, fibreglass or silicone trays, on which the moulds of the gummies have been previously placed through a machine called Mogul or equivalent machine. The moulds are the shapes, in other words, bear, fruits, tablets, capsules, granules, etc. . . . . These moulds are filled with the final dough.
Drying the filled moulds in rooms where moisture and temperature are controlled until the gummy can be demoulded.
Demoulding the gummy, ensuring that the maximum temperature of 90° C. is not exceeded.
Packaging the jellies once unmoulded either in bulk or in daily, weekly, monthly, bimonthly or quarterly application forms.

It is essential to highlight that the first phase of production, the so-called base dough must be made at a maximum temperature of 80° C. and with a moisture content of no more than 25% and a pH between 1 and 4.5, in order to achieve a homogeneous mixture, preserve the organoleptic characteristics of the fruit and the correct stability of the final gummy.

The functional ingredients that we use to incorporate into the mixes are common ingredients, but these ingredients must meet specific pharmacotechnical characteristics and, in most cases, have not previously been incorporated into a gummy with a majority fruit base, so that the fruit-rich, low-carbohydrate gummy with functional ingredients final product is novel.

Unless otherwise indicated, all the technical and scientific elements used in the present specification have the meaning that is usually understood by the person of average skill in the art to which this invention belongs. Similar or equivalent methods and materials to those described herein may be used in the practical embodiment of the present invention.

Throughout the description and the claims, the word “comprises” and its variants do not intend to exclude other technical features, additives, components or steps. For those skilled in the art, other objects, advantages and features of the invention may be partially deduced from both the description and the embodiment of the invention.

### Preferred Embodiment of the Invention

A possible embodiment of the gummy object of the invention is carried out by means of a method comprising the steps of:
1. On the one hand, first, a base dough is prepared. which is going to make up the gummy by mixing fruit in any of the ways described above, that is, in the form of pure fruit, fruit juice, dehydrated powder, concentrate, freeze-dried or other natural fruit, sugar and/or glucose syrup preparations and/or vegetable, animal, synthetic or fermentation fibres and/or sweeteners, water and gelatine or pectin or agar-agar or starch or collagen or carragenates or other gelling agents. Sources of carbohydrates other than fruit, the maximum amount of which cannot exceed 18.78% can be sugars, fibres such as polydextrose and other vegetable fibres such as Fructologosaccharides. Fruit sources will be mainly, but not exclusively, semi-solid, since we have verified that both the powder fruit and that which is in a liquid or chopped state, can be part of this new gummy or pharmaceutical form. These ingredients could be organic and therefore call the product as such. The exact amounts of ingredients common to other gummies (gelling agent, aromas, colourings, carbohydrates, acid, etc.) are not always the same, but each factory plays with certain proportions that in the end will give the gummy a texture, consistency and organolepsy specific to the gummy. In this invention it is specified that the minimum amount of fruit will be 75% of the final composition of the gummy, therefore, in this first phase of preparation, the initial dough must have a minimum amount of 75% fruit, as well as a maximum amount of 25% carbohydrates not from fruit.
   This base dough must meet a series of key specifications such as not exceeding a pH of 4.5, homogenising at a maximum temperature of 80° C., maintaining a density of less than 0.9 g/ml and a Brix graduation of more than 70. The achievement of all these parameters is the main difficulty that must be overcome during the manufacturing process.
   In a possible embodiment, this base dough in turn, may comprise the steps of:
      a first phase of mixing the gelling agents, preferably pectin, together with dry acids.
      a second phase of adding the mixture of gelling agents and acids to a stirring fruit juice concentrate until complete dissolution is guaranteed, where the following must be met
         Stirring time: approx. 30-40 min.
         Temperature of at least 50° C.
         Dry Matter before cooking: 71ºBrix
2. Furthermore, in a complementary manner, a mixture is further prepared with the aromas, flavours and other excipients that interfere with the organolepsy of the gummy, as well as the pH, which is basic for the gummy to finally gel and become consistent. This mixture is called Organoleptic dough.
3. Next, a mixture of one or more functional ingredients is prepared, which will consist of mixing one or more active ingredients, either food or pharmaceutical. This preparation will be made through a homogenisation of the ingredients that allows their incorporation into the final Mixture described below, in a stable manner that guarantees their non-degradation.
4. Next, all previous doughs, that is, the base dough, the Organoleptic dough and the functional ingredients dough are mixed in a single dough called final Mixture or dough. This mixing must be done at a maximum temperature of 90° C. and a moisture of less than 25% and with a maximum pH between 2-7.5 to guarantee the conservation of the active ingredients that provide functionality to the gummy. The mixing of the doughs must be done at low revolutions, with a gentle and constant stirring process and for a maximum time of 30 minutes in order to avoid the start of the gelling process in the mixing tanks.
   The characteristics of this dough should be:
      Dry matter after cooking: 70-80° Brix.
      Output temperature: 70-90° C.
      Output pH: 2-7.5.
Deposited pH (after adding acid): 2.5-7.5.
5. Depositing this mixture in trays with a starch base or on metal, plastic, fibreglass or silicone trays, on which the moulds of the gummies have been previously placed through a machine called Mogul or equivalent machine. The moulds are the shapes, in other words, bear, fruits, tablets, capsules, granules, etc. . . . . These moulds are filled with the final dough.
6. —Drying the filled moulds in rooms where moisture and temperature are controlled until the gummy can be demoulded.
7. Demoulding the gummy, ensuring that the maximum temperature of 90° C. is not exceeded.
8. Packaging the gummies once unmoulded either in bulk or in daily, weekly, monthly, bimonthly or quarterly application forms.

It is essential to highlight that the first phase of production, the so-called base dough must be made at a maximum temperature of 90° C. and with a moisture content of no more than 25% and a pH between 1 and 4.5, in order to achieve a homogeneous mixture, preserve the organoleptic characteristics of the fruit and the correct stability of the final gummy.

As previously explained, it is the object of the invention, in addition to the specific manufacturing process described, a gummy with functional ingredients comprising:
1.—Fruits: 75-91.78%
2.—Carbohydrates and/or sweeteners not from fruit: 1-18.78%
3.—Gelling agents: 1-10%
4.—Aromas: 0.01%-5%
5.—Colourings: 0.01%-5%
6.—Functional ingredients (Food and Pharmaceutical): 0.1-25%
7.—Water: 5-25%
8.—Acid: 0.1-5%

In addition, it comprises aromas, flavours and other excipients that interfere with the organolepsy of the gummy, as well as with the pH and pH correctors

Wherein the percentages are percentages by weight of the final composition.

The sum total of the described ingredients must add up to 100% and no less than 75% must be fruit.

Among the embodiments that can be achieved are: a gummy rich in fruit and with multivitamins, as a pharmaceutical source of vitamins, a gum rich in fruit with melatonin that aids in sleeping or a gum rich in fruit with a pharmaceutical ingredient such as ibuprofen, paracetamol or antibiotic to carry out a treatment under the supervision of health professionals.

In a possible preferred and never limiting embodiment, for preparing jelly beans with 75% fruit juice, the steps that are carried out are:
Preparing a base dough in turn comprising the steps of:
   Adding a juice to the mixing tank and heating at 65-70° C.
   Mixing powders. This phase is very important since the recipe does not contain sugar and it is necessary to mix the pectin with the acids to avoid, as far as possible, the generation of lumps of the gelling agent
   Adding the powder mixture to the juice and stirring for 20 minutes for the pectin to be hydrated
   Vacuum cooker cooking between 5 and 58 seconds at 80-120° C. Vacuum pressure 0.5-0.6. The input dry matter in the cooker is very low (71%), it is necessary to apply sufficient vacuum to be able to raise the dry matter by 2-2.5% so that the product can carry out a correct gelation.
Preparing a mixture with the aromas, flavours and other excipients that interfere with the organolepsy of the gummy, as well as the pH, which is basic for the gummy to finally gel and become consistent. This mixture is called Organoleptic Dough, which in this embodiment consists of customising the paste with the desired colour.
Next, a mixture of one or more functional ingredients is prepared, which will consist of mixing one or more active ingredients, either food or pharmaceutical, which in a preferred embodiment acid is added in a 1:1 solution to acidify the medium and allow the ingredient to gel.
Next, all previous doughs, that is, the base dough, the Organoleptic dough and the functional ingredients dough are mixed in a single dough called final Mixture or dough.

Having sufficiently described the nature of the present invention, as well as how to put it into practice, it is noted that, within its essentiality, it may be implemented in other embodiments that differ in detail from the one indicated by way of example, and to which the protection being sought will also reach, as long as it doesn't alter, change or modify its fundamental principle.

1. A gummy or jelly bean with fruit and with functional ingredients wherein the amount of fruit is at least 75% by weight of the final composition and with a maximum amount of 18.78% carbohydrates not from fruit, wherein the composition of this gummy is:
Fruits: 75-91.78%
Carbohydrates and/or sweeteners: 1-18.78%
Gelling agents: 1-10%
Aromas: 0.01%-5%
Colourings: 0.01%-5%
Functional ingredients (Food and Pharmaceutical): 0.1-25%
Water: 5-25%
Acid: 0.1-5%
Wherein the sum total of the ingredients described must add up to 100% and not less than 75% must be fruit, it also has aromas, flavours and other excipients that interfere with the organolepsy of the gummy, as well as with the pH and pH correctors.

2. A process for manufacturing gummies or jelly beans with fruit and with functional ingredients according to claim 1, wherein the manufacturing process comprises the steps of:
Preparing a base dough by mixing fruit in the form of pure fruit, fruit juice, dehydrated powder, concentrate, freeze-dried or other natural fruit preparations. and sugar and/or glucose syrup and/or vegetable, animal, synthetic or fermentation fibres and/or sweeteners, water and gelatine or pectin or agar-agar or starch or collagen or carragenates or other gelling agents where carbohydrate sources other than fruit, the maximum amount of which cannot exceed 18.78% can be sugars, fibres such as polydextrose and other vegetable fibres such as Fructologosaccharides, where this base dough must meet a series of key specifications such as not exceeding a pH of 7.5, homogenising at a maximum temperature of 80° C., maintaining a density of less than 0.9 g/ml and a Brix level of more than 70, wherein the minimum amount of fruit will be 75% of the final composition of the gummy,
Preparing a mixture with the aromas, flavours and other excipients that interfere with the organolepsy of the gummy, as well as the pH, which is essential for the gummy to finally gel and become consistent, hence this mixture is called organoleptic dough,
Preparing a mixture of one or more functional ingredients that will consist of mixing one or more active ingredients, either food or pharmaceutical. This preparation will be made through a homogenisation of the ingredients that allows their incorporation into the final Mixture described below, in a stable manner that guarantees their non-degradation,
Mixing all the previous doughs, that is, the base dough, the Organoleptic dough and the functional ingredients dough are mixed in a single dough called final Mixture or dough, this mixing must be done at a maximum temperature of 90° C. and a moisture of less than 25% and with a maximum pH between 1-7.5 to guarantee the conservation of the active ingredients that provide functionality to the gummy where the mixing of the doughs should be done at low revolutions, with a gentle and constant stirring process and for a maximum time of 30 minutes in order to avoid the start of the gelling process in the mixing tanks,
Depositing this mixture in trays with a starch base or on metal, plastic, fibreglass or silicone trays, on which the moulds of the gummies have been previously placed through a machine called Mogul or equivalent machine, the moulds are the shapes to be given to the jelly beans
Drying the filled moulds in rooms where moisture and temperature are controlled until the gummy can be demoulded,
Demoulding the gummy, ensuring that the maximum temperature of 90° C. is not exceeded, and
Packaging the jellies once demoulded either in bulk or in daily, weekly, monthly, bimonthly or quarterly application forms.

3. The manufacturing process according to claim 2, wherein the base dough, in turn, may comprise the steps of:
a first phase of mixing the gelling agents, preferably pectin, together with dry acids.
a second phase of adding the mixture of gelling agents and acids to a stirring fruit juice concentrate until complete dissolution is guaranteed, where the following must be met
Stirring time: approx. 30-40 min,
Temperature of at least 50° C.,
Dry Matter before cooking: 71° Brix.

4. The manufacturing process according to claim 2, wherein the final mixture or dough has the following characteristics:
Dry matter after cooking: 70-80° Brix,
Output temperature: 70-90° C.,
Output pH: 2-7.5,
Deposited pH (after adding acid): 2.5-7.5.

5. The manufacturing process according to claim 2 wherein:
The preparation of the base dough in turn comprises the steps of:
Adding the fruit source to the mixing tank and heating to 65-70° C.,
Mixing powders to avoid the generation of lumps of the gelling agent as much as possible,
Adding the powder mixture to the juice and stirring for 20 minutes to allow the gelling agent such as pectin to be hydrated,
Vacuum cooker cooking 5-58 seconds at 80-120° ° C. Vacuum pressure 0.5-0.6, the input dry matter in the cooker is very low (71%), it is necessary to apply sufficient vacuum to be able to raise the dry matter by 2-2.5% so that the product can carry out a correct gelation,
Preparing a mixture with the aromas where the Organoleptic dough consists of customising the paste with the desired colour,
Next, a mixture of one or more functional ingredients is prepared, which will consist of mixing one or more active ingredients, either food or pharmaceutical, which in a preferred embodiment, acid is added in a 1:1 solution to acidify the medium and allow the pectin to gel,
Mixing all the previous doughs,
Depositing this mixture in trays on which the gummies moulds have previously been placed, and
Drying the filled moulds.
